(19) United States
(12) Patent Application Publication
(10) Pub. No.: US 2021/0407024 A1
(43) Pub. Date: Dec. 30, 2021

(54) Child Support Lending and Finance System

(71) Applicant: National Family Services Patent Holdco, LLC, Loveland, CO (US)

(72) Inventor: Frank Jozef Kristan, North Charleston, SC (US)

(21) Appl. No.: 16/914,322

(22) Filed: Jun. 27, 2020

(51) Int. Cl. G06Q 50/18; G06Q 20/10; G06Q 40/02

(52) U.S. Cl. CPC G06Q 50/18; G06Q 50/22; G06Q 40/025; G06Q 20/10

(57) ABSTRACT

A child support financing system may provide a guaranteed payment for a custodial parent with an agreement by a non-custodial parent to pay a financed amount. A financing arrangement may provide a loan for previous underpayments, so that any back-support owed the custodial parent may be caught up, and the non-custodial parent may be given terms that are more financially achievable. An automated system may process and underwrite loans for non-custodial parents to make up back payments. The loan may fund a trust account or other mechanism that guarantees future payments. In many cases, the payments to the custodial parent may be administered by a state or federal agency. If the financing arrangement is in default for non-payment, a state or federal agency may collect the amount due from the non-custodial parent.

### BACKGROUND

Child support payments are typically court ordered or court approved agreements for a non-custodial parent to pay a custodial parent after a marriage dissolution. Such agreements are intended to ensure that the custodial parent has the proper financial support to raise a child. Both state and federal law recognize the importance of the child's well-being and have various enforcement measures in place to ensure compliance.

Notwithstanding these court-ordered requirements of payments, many non-custodial parents fall behind on their payments. Such a failure to pay can put the child's welfare in jeopardy, at least in the short term.

### SUMMARY

A child support financing system may provide a guaranteed payment for a custodial parent with an agreement by a non-custodial parent to pay a financed amount. A financing arrangement may provide a loan for previous underpayments, so that any back-support owed the custodial parent may be caught up, and the non-custodial parent may be given terms that are more financially achievable. An automated system may process and underwrite loans for non-custodial parents to make up back payments. The loan may fund a trust account or other mechanism that guarantees future payments. In many cases, the payments to the custodial parent may be administered by a state or federal agency. If the financing arrangement is in default for non-payment, a state or federal agency may collect the amount due from the non-custodial parent.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a financing system for child support payments.

FIG. 2 is a diagram illustration of an embodiment showing a schematic or functional representation of a network with a financing system for child support payments.

FIG. 3 is a diagram illustration of an embodiment showing a financing process for child support.

FIG. 4 is a diagram illustration of an embodiment showing an application for child support financing.

FIG. 5 is a flowchart illustration of an embodiment showing a method for an application process for child support financing.

FIG. 6 is a flowchart illustration of an embodiment showing a method for setting up and managing child support financing.

### DETAILED DESCRIPTION

### Child Support Payment Financing System

A child support payment financing system may provide guaranteed payments to a custodial parent pursuant to a non-custodial parent's agreement or obligation to pay child support. A non-custodial parent's obligation to pay may be through contractual agreement or through a court order, and, in many instances, a state or government agency may facilitate the transactions.

In a vast number of cases, non-custodial parents fall behind in their payments, which can cause hardship on the child. In recognition of this stress, many states and the federal government have systems in place to collect child support obligations from a non-custodial parent. The inability or unwillingness of a non-custodial parent to meet their court-ordered obligations has led to literally billions of dollars in overdue payments.

The child support financing system guarantees a court-ordered payment obligation will be met. Whether or not the non-custodial parent is making timely payments, the financing system pays the custodial parent according to the court-ordered schedule. Payments by the non-custodial parent may be made over a longer period of time and may accrue interest if the non-custodial parent falls behind. Because the payments to the custodial parent are funded and guaranteed, the child and the custodial parent should not suffer hardship for lack of the payments.

A non-custodial parent may run into different circumstances that may cause them to fall behind on providing for their progeny. Arrest and incarceration, unemployment, reduced hours at work, seasonal changes in work, accident or sickness are just examples of the trials that may beset a non-custodial parent.

In some cases, the non-custodial parent may refuse to pay based on emotional issues, such as anger, resentment, and the like, many of which occur during divorce or dissolution of a relationship.

A child support financing system may allow a non-custodial parent to meet their obligations of support by paying over an extended period. Such a system may benefit the custodial parent by ensuring reliable and consistent income to support the child, while allowing the non-custodial parent the flexibility to pay in different circumstances.

In a state-managed child support system, a non-custodial parent may make payments to a state agency and the state agency may pay the custodial parent the amount received. A state, federal, or other governmental agency may have the authority to garnish wages, enforce payroll withholding, or issue warrants or arrest for failure to pay child support payments. Some child support arrangements are private such that a non-custodial parent may pay the custodial parent directly and no such state agency may be involved.

A child support financing system may separate the custodial parent's income from the non-custodial parent's ability to pay. A trust account or other guaranteed payment mechanism may ensure that the custodial parent always receives the payment they are due. If a non-custodial parent falls behind on their obligation, the money advanced to the custodial parent will become a loan that the non-custodial parent will then be obligated to pay.

In some cases, the parents may use a child support financing system to create a loan based on back support that may already be owed. For example, a non-custodial parent may be behind on payments. A loan will be originated and used to meet the back support obligation by paying the custodial parent, then the non-custodial parent's payment terms may be adjusted or extended such that the loan may be paid back over time.

Some government programs may provide assistance to a custodial parent due to a non-custodial parent's failure to pay. In such cases, the assistance from the government program may act as an advance to the custodial parent, and the government program may require repayment of some or all of the amount from the non-custodial parent. In such situations, the child support financing service may pay some or all of the government obligations as part of a loan made to the non-custodial parent.

A child support financing system may operate by receiving an assignment of the non-custodial parent's obligation from the custodial parent. Sometimes, such an assignment may be known as subrogation, where the financing system may then receive all future payments from the non-custodial parent.

The financing system may also include an agreement by the non-custodial parent for any adjustments to the payment schedule. In cases where a loan may be created because of back support that is owed, the non-custodial parent's repayment terms may be extended. In some cases, the new repayment terms may extend past the child's date of emancipation.

A child support financing system may receive an application for financing. The application may include an agreement by the non-custodial parent to new payment terms, such as extension of the payment time or a change to the periodic amount of payments. The application may include copies of the current court ordered payments. An application may include financial statements from government agencies that may administer the court ordered payments. Such financial statements may indicate when the payments were actually made, along with any balances currently due and past due.

An underwriting process may evaluate the suitability of the situation for financing. In general, states have enacted powers to garnish wages, encumber assets, and other mechanisms for collection of child support payments, including even arrest and incarceration. In many cases, these collection and enforcement mechanisms may be available even when the custodial parent may have assigned or subrogated the future payments to the child support financing system.

In some cases, an underwriting process may use credit history, job history, tax returns, bank statements, or other financial, social, job, education, or other historical data about the non-custodial parent to determine terms for financing.

A new or modified court order may be entered once the application and underwriting process has been completed. The new court order may obligate the child support financing system to fund all future payments to the custodial parent, as well as modify the payment terms of the non-custodial parent. The new court order may also redirect the payments from the non-custodial parent to the child support financing system.

The child support financing system may have a web or application interface through which one or more of the parties may apply for and manage their financing.

A non-custodial parent may initiate an application through a web page or application by requesting the financing and providing information about themselves and their situation. In some cases, such an application may include providing information about the custodial parent, and the system may reach out to the custodial parent to obtain their consent for the use of the financial system. Such an outreach may be as simple as an email, SMS, telephone, or mail contact to the custodial parent explaining the situation and requesting their participation.

A non-custodial parent may request child support financing services when the parent is behind on payments, has struggled to meet their payment obligations, or wishes to restructure their payments to be more affordable.

In other situations, the custodial parent may initiate an application for financing. The custodial parent may have experienced missed or inconsistent payments, be owed back support, or otherwise be concerned about the non-custodial parent's ability to pay consistently.

In still other situations, a state case worker, court, magistrate, advisor, or other person may initiate an application on behalf of the parents. Such a situation may arise, for example, when government aid or assistance has been extended to the custodial parent due to the non-custodial parent's inability or unwillingness to pay child support. In some cases, an attorney representing either parent may initiate the child support financing process.

The web based or application through which an application may be created and managed may identify the parties of interest. This may include the custodial and non-custodial parents, and in some cases, a case worker, social worker, magistrate, judge, or other government official that may be involved in administering, monitoring, or adjudicating the matter.

The application process may provide an input mechanism for a non-custodial parent to explain why they have not been able to make the previous payments. In some such systems, the non-custodial parent may be able to provide information regarding a change in circumstances which may justify a change in payments. Such information may be considered by a judge or magistrate who may determine that a reduced or changed set of payments may be appropriate.

Similarly, the application process may also provide an input mechanism for a custodial parent to indicate why an increase or other change in payments may be appropriate.

When an application process includes a request for changing the payments made to the custodial parent and the non-custodial parent's obligation to pay, both parties may be given the opportunity to provide evidence and explanation supporting their argument. Such evidence might be in electronic form and part of an electronic file.

Once underwriting has determined that financing is appropriate and that the financing entity will guarantee the future payments, including back support if appropriate, the changes may be submitted to a court for approval. In many cases, the system may generate the appropriate paperwork for the court to review and sign. The court may issue a new or modified court order that obligates the financing entity to pay all future payments and, in exchange, the payments made by the non-custodial parent will be transferred to the financing entity.

After receiving a court order to modify the child support arrangement with the financing, a financial entity may begin managing the child support arrangement. The financial entity may pay any back support or missing payments to a custodial parent. In some cases, may repay any government entity amounts that may have been advanced through government assistance programs to the custodial parent.

The non-custodial parent's payments may be directed to the financial entity, which may be authorized through an assignment by the custodial parent. If the non-custodial parent may miss a payment or be delinquent, the financial institution may re-calculate the amount of money owed and adjust the future payment schedule. In cases where the custodial parent becomes severely delinquent, the financial institution may alert one or more governmental agencies to assist in collecting child support payments from the non-custodial parent.

Throughout this specification and claims, reference is made to a “custodial parent” and a “non-custodial parent.” In many cases, parents may share custody, but the term “non-custodial parent” is used merely to denote the parent who has an obligation to pay the “custodial parent” in a child support situation.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

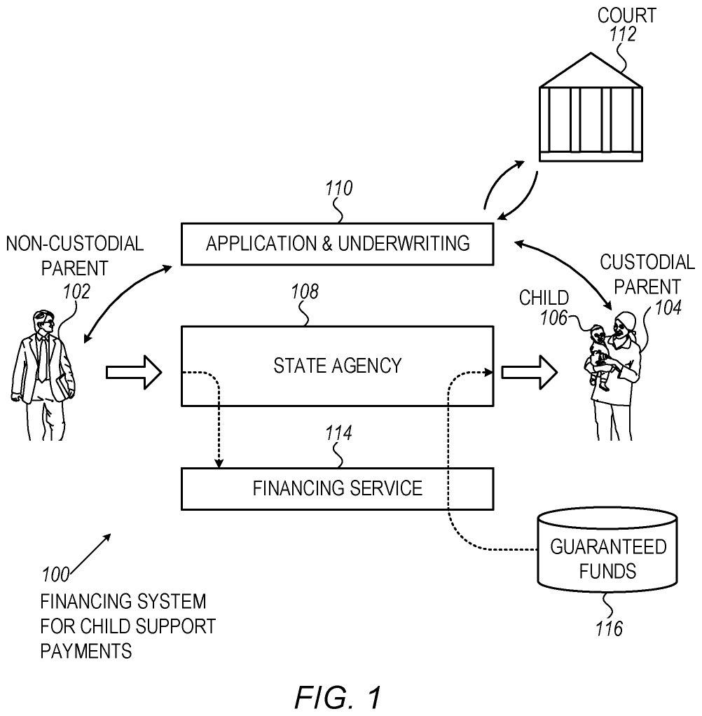

FIG. 1 is a diagram illustration of an example embodiment 100 showing a financing system for child support payments. Following a dissolution of marriage or civil partnership, or for any other court-ordered child support arrangement, a non-custodial parent 102 may be obligated to pay a custodial parent 104 who may be the primary caregiver of a child 106. In a typical arrangement, the payments may be monthly, bi-weekly, twice-monthly, quarterly, seasonal, or have some other cadence.

Some child support arrangements are facilitated by a state agency 108. Many states have a “child support services agency” or other similar agency whose mission is to assist children. One part of the mission may be to collect and distribute child support payments. The agency 108 may collect payments from the non-custodial parent 102 and may forward those payments to the custodial parent 104. The agency 108 may also have strong mechanisms for collecting child support payments, including garnishment of wages or other financial assets, denial of licensure or other government services, even arrest and imprisonment for failure to pay child support payments.

A system for financing the child support payments may begin with an application and underwriting system 110, which may collect information about the case from the parents and obtain an updated or modified court order from a court 112. When the court order may be issued, a financing service 114 may provide guaranteed funds 116 that may guarantee the future payments to the custodial parent 104. The financing service 114 may create a loan that may pay any back support or owed monies to the custodial parent 104.

The financing service 114 may allow the non-custodial parent 102 to meet their court-ordered obligations over a longer period of time by financing their child support payments. Because the custodial parent 104 may have guaranteed funds 116, future payments may be made on time, regardless if the non-custodial parent 102 is faithful in making payments. The financing service 114 may make up the difference by loaning the money to the non-custodial parent 102.

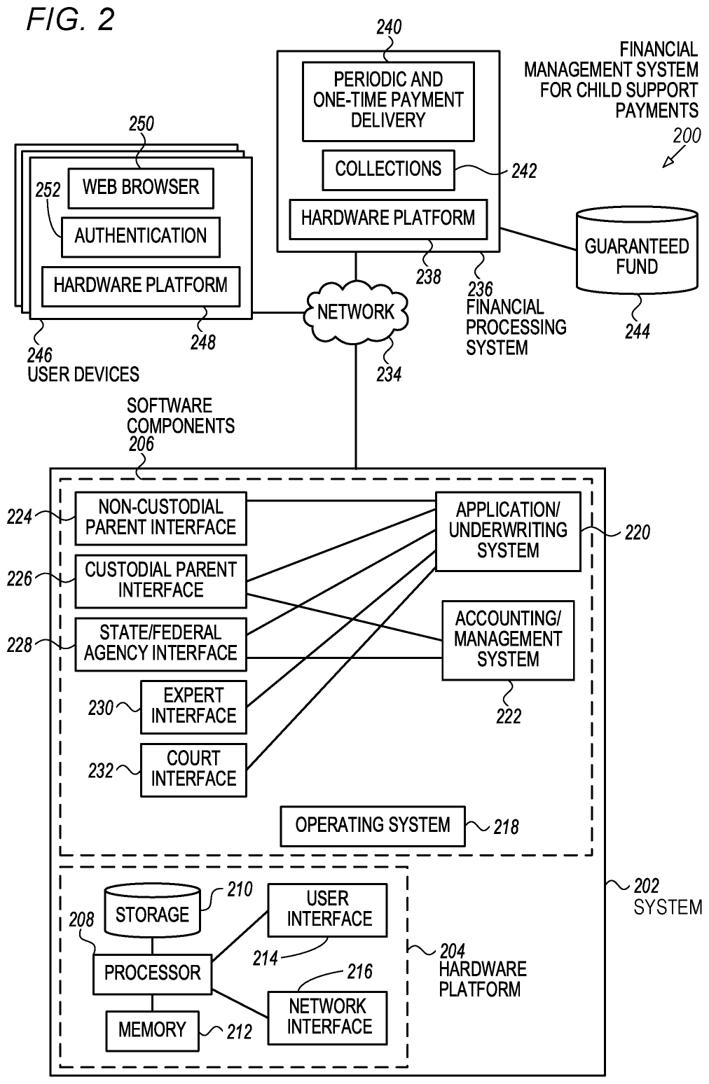

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a system 202 that may have a hardware platform 204 and various software components. The system 202 as illustrated represents a conventional computing device, although other embodiments may have different configurations, architectures, or components.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the system 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

An application and underwriting system 220 and an accounting management system 222 may provide the functions of preparing and managing a new financing agreement for child support payments, respectively.

The application and underwriting system 220 may serve to create an application for financing, obtain the relevant information, and facilitate an updated agreement between the parties, which may be approved by a court.

The accounting management system 222 may take over once the court order is in place and handle the financial transactions. The accounting management system 222 may provide current accounting of all transactions, as well as collect missing payments and the like.

A non-custodial parent interface 224 and custodial parent interface 226 may be where a parent may begin an application process, provide input to the application, monitor an application going through the process, and manage payments once the financing is in place.

A state or federal agency interface 226 may be where a state or federal agency may interact with the systems. A state or federal agency may provide evidence of payments or lack of payments, provide input to the application and underwriting processes, as well as monitor and manage payment distribution and collection once the financing is in place.

An expert interface 230 may be an interface where third parties may provide input to the application process. Such input may be used by the parents, the underwriters, state agencies, the courts, or other parties that may participate in the child support process.

A court interface 232 may be an interface where a court may interact with the process to receive information prior to adjudication, evaluate and adjudicate a matter, and monitor the progress of the matter after the fact.

A network 234 may connect the system 202 to other devices.

A financial processing system 236 may implement, manage, and report the child support payments. The system may operate on a hardware platform 238 and may provide periodic and one time payment delivery 240 as well as collections 242. The financial processing system 236 may distribute funds from guaranteed funds 244.

Various user devices 246 may be used to interact with the system 202. The user devices 246 may be used by the parents, state or federal agencies, experts, courts, or other parties to interact during the application process or during the operational phase of distributing and managing the child support payments. The user devices 246 may operate on a hardware platform 248 using a web browser 250 or other application. In many cases, an authentication system 252 may provide authentication services to validate the users have permission to perform their interactions with the services.

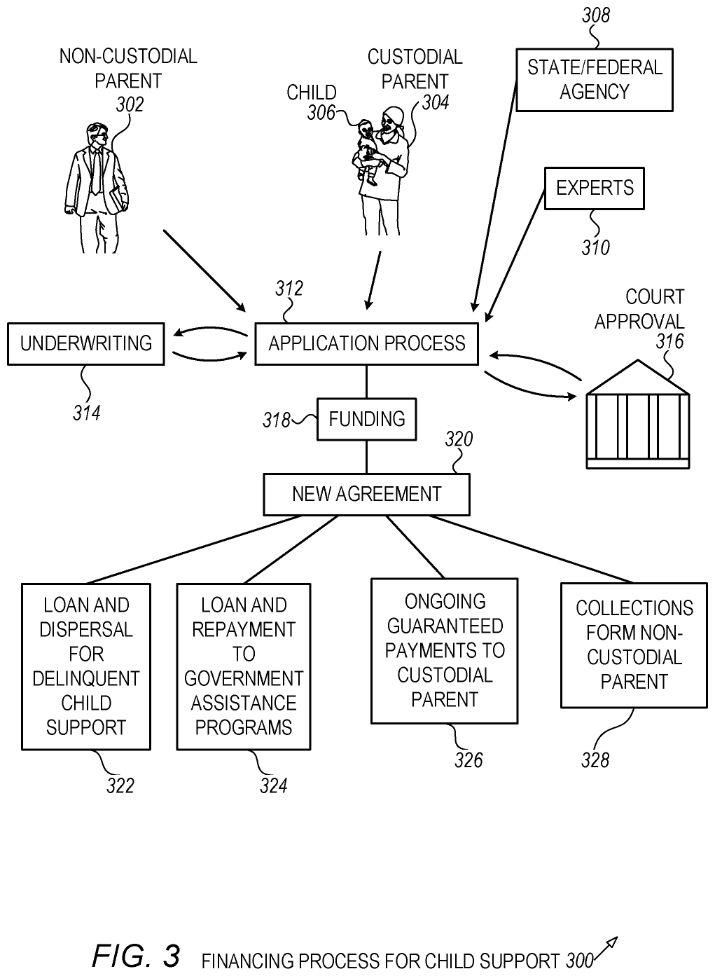

FIG. 3 is a diagram illustration of an embodiment 300 showing a financing process for child support. During the application process 312, several parties may be involved. The parties may include a non-custodial parent 302, a custodial parent 304 who has the child 306 for which support payments are mandated, one or more state or federal agencies 308, as well as various experts 310.

During the application process 312, information about the situation is gathered and, to the extent possible, agreement may be reached between the parties. In cases where agreement is not reached, a court may adjudicate the differences.

The application process may gather information about the case. The documented evidence may include an existing court order that may have previously defined child support payments. Additional evidence may include payment history, which may be documented by one or both of the parents or by a state agency.

In some cases, one or both of the parents may wish to change the child support payments. For example, a non-custodial parent may have fallen onto hard times and may be ill or unable to find employment. A custodial parent may have increased need for support because the child has specific needs or the custodial parent may not be able to provide. In such cases, the application process 312 may include mechanisms so that the parties may request changes and provide explanation and evidence supporting the changes. Such requests may be evaluated by various experts 310 and eventually forwarded to the courts for adjudication or approval.

Some systems may allow attorneys to represent the parents during the application process 312. The attorneys may be given access on behalf of their clients, and the attorneys or their staff may be the people interacting with the application process 312 rather than the parents.

In other use cases, one or both of the parents may be able to manage the application process on their own. Such systems may have simplified user experiences, complete with helpful elements, such as explanations of the options and availability of experts to assist during the application process.

After court approval 316, a new court order may be issued that establishes a new or updated child support arrangement. The funding stage 318 may provide the guaranteed funds for future payments, and the new agreement 320 may be implemented.

Under the new agreement 320, a loan may be originated and disbursed to the custodial payment for delinquent child support 322. Some cases may involve a loan and full or partial repayment to government assistance programs 324. The funding may provide for ongoing guaranteed payments to the custodial parent 326, as well as the mechanisms to collect payments from the non-custodial parent 328.

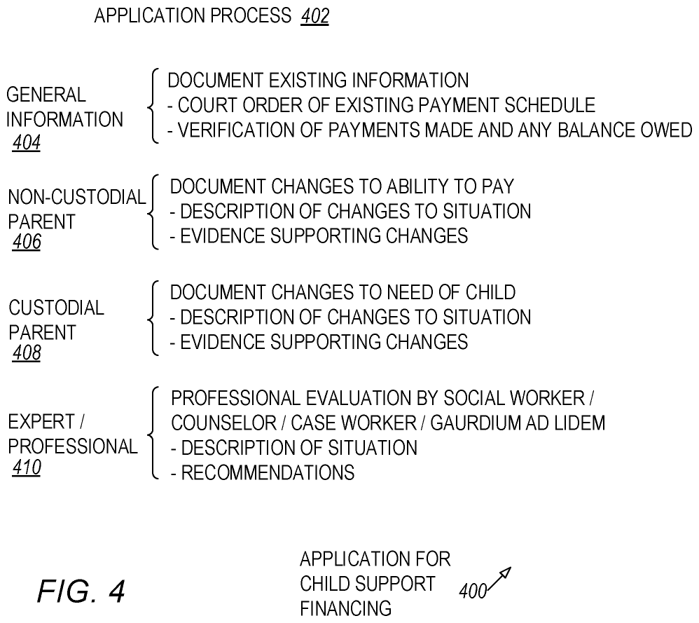

FIG. 4 is a diagram illustration of an embodiment 400 showing components that may be part of an application for financing of child support payments.

The application 402 may include general information 404. General information 404 may include the court order that established a previous set of child support payments as well as verification of payments made to date and any outstanding, overdue, or delinquent payments. In situations where a government agency has provided assistance to the custodial parent, some such government programs may require full or partial repayment of the assistance when the non-custodial parent pays. During the application process, such amounts may be gathered from the appropriate government agency.

The non-custodial parent 406 may provide information about themselves. In many cases, the application may include the non-custodial parent's current and past work history, as well as bank statements and other financial disclosures. The financial disclosures may include pay stubs, receipts from their business, W2 forms, tax returns, and other financial disclosures.

The non-custodial parent 406 may include a request to change the child support arrangements in the application. Such a request may include a narrative or other description of the specific situation, as well as evidence supporting the changes. In some cases, the application process may be simple enough that a layperson may be able to submit a request. In other cases, the application process may involve a caseworker, lawyer, or other professional advocate who may gather and enter the description and evidence of a change request.

Similarly, a custodial parent 408 may also include a request to change the child support arrangement. In many cases, the custodial parent's situation may change, or the child's needs may have changed. A request for a change may include a narrative description of the request along with evidence supporting the change.

An expert or professional 410 may have input to the application process. The expert or professional may be a social worker, case worker, counselor, guardian ad litem, teacher, care giver, medical professional, mental health professional, or any other person with knowledge of the family situation. The expert or professional may provide description of the family situation, any changes to the family situation since the previous court order, and any recommendations by the professional.

The application may be sent to a court for evaluation and possible modification of court orders. In situations where both parents consent to the changes and those changes are not unreasonable, a judge or magistrate may approve the changes readily. Where small differences exist, the court may make a ruling using the application alone or may request more information from the parties before making a ruling. Where large difference exist, the court may require a new trial to fully adjudicate the matter.

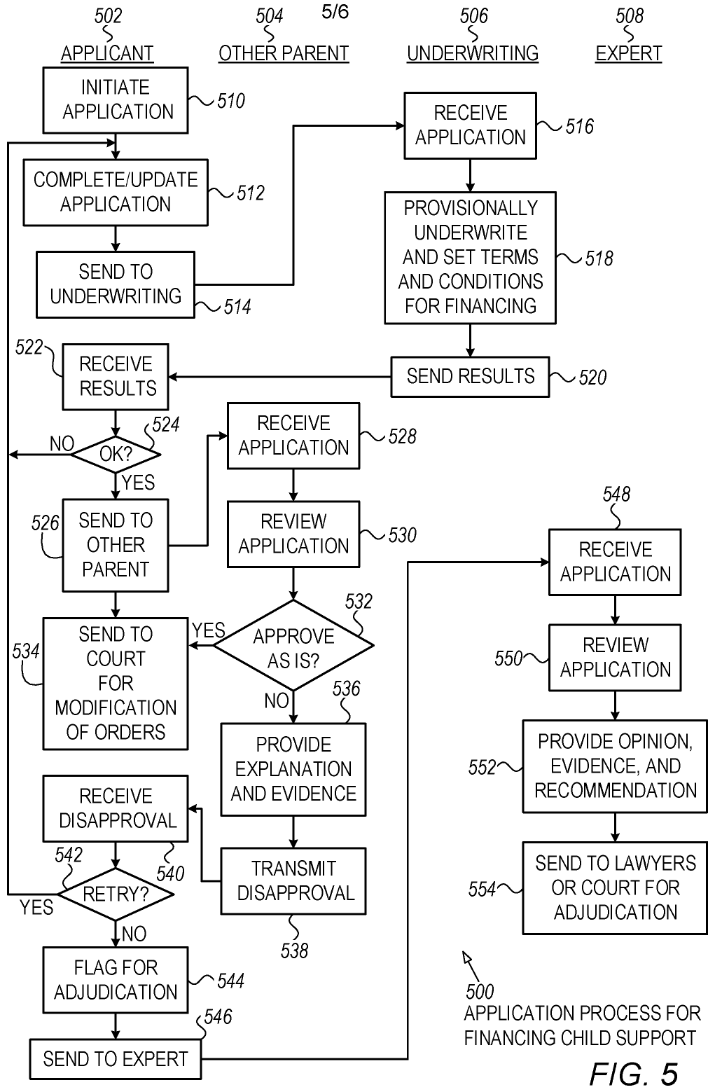

FIG. 5 is a flowchart illustration of an embodiment 500 showing an application process for financing child support. The actions performed by the applicant 502 are shown in the first column, the actions performed by the other parent 504 are shown in the second column, the actions performed by underwriters 506 are shown in the third column, and actions performed by experts 508 are shown in the fourth column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In the method of embodiment 500, either parent may initiate an application for child support financing. In one scenario, a custodial parent may be worried about the non-custodial parent's ability to pay consistently, so the custodial parent may wish to have child support financing so that the payments may be reliable and guaranteed, causing that parent to initiate an application. In another scenario, a non-custodial parent may have fallen behind in their payments and apply for child support financing so that they can bring their accounts current and avoid legal ramifications of being behind.

The applicant 502 may initiate an application in block 510 to complete or update an application in block 512. The application may be sent to underwriting in block 514.

Underwriting 506 may receive the application in block 516 and may provisionally underwrite the financing in block 518, then send the results in block 520 to the applicant 502. The provisional underwriting may approve or deny financing based on the information in the application. In some cases, the underwriting may place conditions or other requirements on one or both parties for the financing.

The application 502 may receive the underwriting results in block 522. If the results are not favorable, or if underwriting requests more information in block 524, the process may return to block 512 where the applicant 502 may add information to or update the application and resubmit to underwriting.

If the underwriting results are not favorable or if the applicant 502 does not wish to proceed, the applicant 502 may abandon the application process.

If the underwriting results are favorable and the applicant 502 wishes to continue, the applicant 502 may forward the information to the other parent in block 526.

The other parent 504 may receive the application information in block 528 and review the application in block 530. If the other parent 504 approves the application as-is in block 532, the application may proceed to be filed with the court for modification of orders in block 534.

If the other parent 504 does not approve the application in block 532, the other parent 504 may provide explanation and evidence in block 536 regarding their situation or disapproval, and may transmit the disapproval in block 538

The applicant 502 may receive the disapproval in block 540. If the applicant 502 chooses to retry the application process in block 542, the process may return to block 512 where the applicant 502 may modify the application and resubmit.

The applicant 502 may retry the application process when the two parents are reasonably close to an agreement. In general, courts can be very receptive to a change to child support payments, including financing, when both parties are in agreement. However, when the parties have a disagreement, the application may be flagged for adjudication in block 544.

Once flagged for adjudication in block 544, the application may be sent to one or more experts 508 in block 546. The experts 508 may receive the application in block 548, review the application in block 550, and provide an opinion, evidence, and a recommendation in block 552. The results may be transmitted to the parent's attorneys or the court for adjudication in block 554.

In the example of embodiment 500, the experts are illustrated as being involved after the parents have attempted to come to an agreement but have not agreed. In some circumstances, expert opinions and recommendations may be requested by one of the parents earlier in the process. For example, an applicant 502 may request an expert opinion and recommendation prior to starting the application process, or the other parent 504 may request expert opinion and recommendation while considering the first parent's application request.

The process of embodiment 500 may be facilitated by a computer-based system. Such a system may be a web page, application, or other interface that may allow an applicant 502 to complete an application. Such systems may guide an applicant 502 through the application process in several ways. First, the system may evaluate the applicant's answers to questions to make sure the answers are properly filled out and that the proper information may be included.

Such application systems may automate certain data collection processes, such as automatically collecting credit scores, verifying work history, verifying driver's licenses, addresses, and other verifiable information.

Such application systems may also guide the applicants through the application process. In one mode, the guidance may include help videos, frequently asked questions, automated or human assisted chat, voice, or video assistance through the application process, or other information to assist the applicants.

The systems may facilitate the sequencing and communication between the parties. For example, a system may allow one parent to fill out the application, which may be automatically sent to underwriting. The system may have an underwriting interface where a human underwriter may be notified of an application, and the human underwriter may review the information on a computer system for approval, denial, or request other information.

In many cases, underwriting may be fully automated where a computerized underwriting algorithm may approve (or at least provisionally approve) an application subject to later human review. Such algorithmic approval processes may consider the facts submitted by the applicants and any verification performed on those fact, then issue an approval when the application meets the pre-defined guidelines. In some such systems, an application may be underwritten in mere seconds when the appropriate information is available.

A system for child support financing may manage communication between the parents. Once the applicant 502 has completed their portion of the application process, the system may notify the other parent 504 of the application and collect information from the other parent 504. Such a notification may be through email, SMS/text messaging, or other electronic communication. The other parent 504 may be authenticated when they establish login credentials to the system, after which they may gain access to the application process.

The system may sequence the steps between different parties, notifying a participant of their next steps and presenting a user interface tailored for that person. Once that person has completed their portion of the process, the system may continue with the next steps.

Some systems may allow the other parent 504 the opportunity to comment, approve, deny, amend, or otherwise interact with the application process. In some situations, the other parent 504 may completely ignore the requests and may refuse to participate. In such situations, an application may be forwarded to the court for approval without the other parent's involvement. A situation may happen, for example, when the parents are not on speaking terms or where one parent intentionally attempts to block the other parent's application process, no matter if the application may eventually benefit the other parent.

When one parent may refuse to participate during the application process or when the other parent may actively oppose a child support financing arrangement, a court may impose the arrangement at its discretion.

In some situations, a case worker, social worker, counselor, or other party may initiate a child support financing application. For example, a state employee case worker who may be managing the parent's child support obligation may determine that a child's wellbeing may be affected by a non-custodial parent's ability or willingness to consistently pay their child support payments. The case worker may initiate a child support financing application on behalf of the custodial parent or child, and the non-custodial parent may receive notice that an application has been started. Both the custodial and non-custodial parents may then respond to the application process.

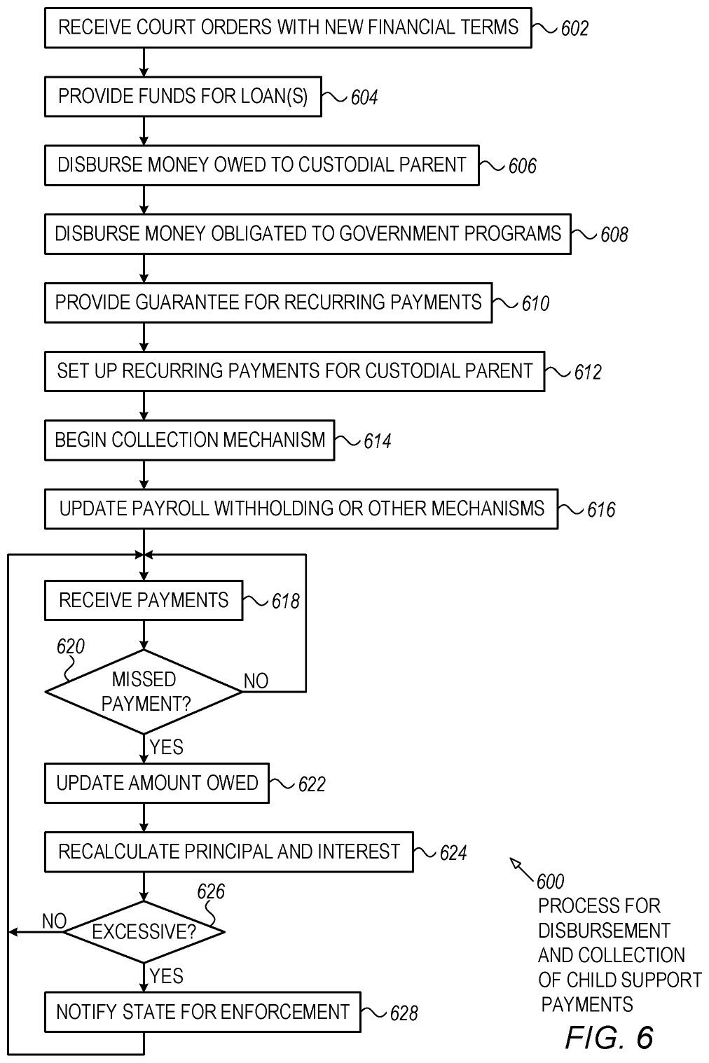

FIG. 6 is a flowchart illustration of an embodiment 600 showing a method for disbursement and collection of child support payments in a financing arrangement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 may illustrate the deployment and collection of funds once a child support financing arrangement may be in place. The new child support financing arrangement may begin with a court order in block 602 establishing new child support payment terms.

The funds for any loans may be provided in block 604. The funds may be guaranteed in block 604 by a financing entity. In some cases, the funds may be placed in a trust account to fully fund any back support that may be owed as well as future payments to be made to the non-custodial parent. In other cases, funds may be guaranteed or pledged on a contractual basis to fund future payments.

Monies that may be owed to the custodial parent may be paid in block 606. These monies may be back support that a non-custodial parent has missed intentionally or unintentionally, but may be owed to the custodial parent. Some or all of the missing payments may be paid out to the custodial parent. In some cases, the custodial parent may receive the payments in a lump sum, while in other cases, the back payments may be made over a period of time.

Some cases may have an obligation to repay government assistance programs which may have provided support to a custodial parent during periods where a non-custodial parent has failed in their support obligation. Such a repayment obligation may be intended to be made when a non-custodial parent regains their financial footing, but in a child support financing arrangement, some or all of that obligation may be repaid through the loan made during the financing arrangement.

The loans of blocks 604, 606, and 608 may be advanced by a financing entity and may be owed by the non-custodial parent. As part of the financing arrangement, the non-custodial parent may agree to repayment terms that may extend past their original obligation.

For example, if a non-custodial parent was behind 12 months on their original obligation, a child support financing arrangement may create a loan for the 12 months of arrears or deficiency, then pay out the owed amount to the custodial parent or government agency. Assuming the non-custodial parent's period payment amount remains the same, the non-custodial parent's payments may extend 12 months or more after the original payments would have ended. The additional payments would be used for paying the loan, interest, fees, and other costs associated with the financing.

In such a repayment arrangement, the non-custodial parent may pay more money than they were originally obligated, but the financing arrangement may allow a longer period or more flexibility in repayment terms.

A guarantee may be made in block 610 for future payments to the custodial parent. The guarantee may be in the form of cash placed in a trust account for the full amount of future payments. In other cases, different types of guarantees or obligations may be made to ensure future payments, such as funding an annuity or purchasing insurance to guarantee all or at least a portion of the future payments. The recurring payments may be setup and automated in block 612 to make the future payments.

In a typical situation, an amortization schedule may be created where the non-custodial parent's payments may be defined. The amortization schedule may include paying off a loan that may have been advanced to cover previous missed payments.

The collection mechanism for collecting from the non-custodial parent may be configured in block 614. A typical collection mechanism may be payroll withholding or garnishments, which may be configured with the non-custodial parent's employer in block 616. When a non-custodial parent may be self-employed or may not receive a conventional paycheck with automatic withholding, other systems may be put in place to collect payments.

Payments may be received in block 618. If a payment is not missed in block 620, the process may continue receiving payments in block 618.

If a payment is missed or is otherwise short or delinquent in block 620, the amount owed by the non-custodial parent may be updated in block 622 and principal and interest payments may be recalculated in block 624.

In some arrangements, a non-custodial parent may be allowed to defer payments or adjust their payments. For example, a child support financing arrangement may permit some number of late payments on a line of credit arrangement where the non-custodial parent may repay the owed amounts at a later date. Such an arrangement may be made when the non-custodial parent has a high credit score, where the parent works on a seasonal or variable income industry, or for some other considerations.

Some financing arrangements may be configured so that payments may be missed when the non-custodial parent shows evidence of unemployment, incarceration, illness, or other conditions. In many financing arrangements, the amount and conditions for missing payments may be defined by contract.

If the amount of missed payments may become excessive in block 626, the state may be notified in block 628 that the non-custodial parent has not met their court-ordered payment schedule. The state may enforce the court order as appropriate to collect the monies owed by the non-custodial parent.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system operable on at least one processor, said system performing a method comprising:
receiving an application for child support financing, said application comprising:
an assignment from said custodial parent assigning a right to receive payments from a non-custodial parent, said assignment transferring said right to a financing entity, said non-custodial parent being subject to a first court order to pay said custodial parent a first series of payments;
underwriting a financing arrangement for said first series of payments, said financing arrangement being obtained through said financing entity;
receiving a second court order modifying said first court order such that said custodial parent receives said first series of payments through said financing arrangement; and
causing said payments from said non-custodial parent to be transferred to said financing entity.

2. The system of claim 1, said method further comprising:
determining that a first payment of said first series of payments is due and causing said first payment to be made by said financing entity and causing said first payment to be transferred to said custodial parent.

3. The system of claim 2, said non-custodial parent having a deficiency on said first series of payments.

4. The system of claim 3, said financing arrangement comprising a loan, said loan being used to pay said custodial parent to make up at least some of said deficiency.

5. The system of claim 4, said loan comprising all of said deficiency.

6. The system of claim 3, said custodial parent having received a government assistance as a result of said deficiency, said government assistance being deemed a government repayment obligation of said non-custodial parent.

7. The system of claim 6, said financing arrangement comprising a loan, said loan being used to pay at least a port of said government repayment obligation.

8-9. (canceled)

10. The system of claim 9, said first part of said government repayment obligation being paid in full by said financing entity.

11. The system of claim 1, said agreement from said non-custodial parent to modify said first series of payments to a second series of payments.

12-17. (canceled)

18. The system of claim 1, said method further comprising:
receiving a statement from a professional and adding said statement to said application.

19. The system of claim 18, said professional being one of a group composed of:
a social worker;
a case worker;
a counselor; and
a guardian ad litem.

20. The system of claim 1, said method further comprising:
receiving said application from said non-custodial parent and transmitting said application to said custodial parent;
receiving an approval from said custodial parent regarding said application; and
transmitting said agreement to a court and receiving said second court order from said court.

21-22. (canceled)

23. The system of claim 1, said method further comprising:
receiving said application from said custodial parent and transmitting said application to said non-custodial parent;
receiving an approval from said non-custodial parent regarding said application; and
transmitting said agreement to a court and receiving said second court order from said court.

24-26. (canceled)

27. The system of claim 1, said application comprising a request to change said first series of payments.

28-30. (canceled)

31. A system operable on at least one processor, said system performing a method comprising:
receiving a court order comprising:
a first set of future payments to be made to a custodial parent;
further receiving:
a financing arrangement of a second set of future payments to be made by a non-custodial parent; and
an assignment of said second set of future payments to a financing entity, said assignment being made by said custodial parent;
guaranteeing said first set of future payments;
establishing a payment mechanism for causing said first set of future payments to be paid to said custodial parent;
establishing a collection mechanism for collecting said second set of future payments from said non-custodial parent.

32. The system of claim 31, said first set of future payments and said second set of future payments being the same.

33. The system of claim 31, said first set of future payments and said second set of future payments being different.

34. The system of claim 31, said first set of future payments comprising a lump sum representing missed child support payments owed but unpaid by said non-custodial parent.

35. The system of claim 34, said lump sum being a loan advanced to said custodial parent.

36. The system of claim 31, said payment mechanism comprising wage withholding.

37-41. (canceled)
